(19) United States
(12) Patent Application Publication
(10) Pub. No.: US 2023/0377026 A1
(43) Pub. Date: Nov. 23, 2023

(54) EMBEDDING TEXTING AND CALLING COMMUNICATIONS INTO MEDIA ITEMS

(71) Applicant: Al Zlogar, Fremont, CA (US)

(72) Inventor: Al Zlogar, Fremont, CA (US)

(21) Appl. No.: 17/749,229

(22) Filed: May 20, 2022

(51) Int. Cl. G06Q 30/06; G06F 16/955; G06F 16/908; H04L 51/02

(52) U.S. Cl. CPC G06Q 30/0643; G06F 16/955; G06F 16/908; H04L 51/02

(57) ABSTRACT

A method for embedding messages into media items is provided. The method includes receiving a media item from a publisher. The media item is associated with at least one of a product and a service. The method continues with receiving metadata associated with at least one of the product and the service from the publisher and generating a widget based on the media item and the metadata. The widget encodes a Uniform Resource Locator (URL) that embeds the metadata associated with the media item and a protocol for accessing a webpage. The method further includes detecting an interaction of an end user with the widget and creating the webpage in response to the detection. The webpage displays the media item based on the metadata and the protocol embedded into the URL and a chat window with communications exchanged between the publisher and the end user.

### TECHNICAL FIELD

This disclosure relates to providing subject-driven communications between parties. More specifically, this disclosure relates to systems and methods for embedding messages into media items.

### BACKGROUND

Content of vendor websites presenting products and services to prospective customers is often disconnected from the communications between the vendors and the prospective customers. In order to communicate with a vendor, a prospective customer has to either manually contact the vendor based on the contact information displayed on the website, or chat with a bot or live operator. However, each time the prospective customer starts communicating with the vendor, the prospective customer needs to provide information for the product the customer is interested in and, in some cases, provide personal information for the customer to enable further communications with the vendor. Moreover, chatbot windows popping up on websites and email communications sent to visitors of the websites are often not contextual because they do not relate to particular products or services viewed by the visitors on the websites. These disadvantages of conventional types of communications provided on websites by vendors reduce conversion rates of the visitors. Furthermore, a high chatbot failure rate, high online cart abandonment rate, and comparatively brief time within which it is possible to capture the customer interest on a website reduce the efficiency of the conventional approaches for engaging the customer.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

Generally, the present disclosure is directed to a technology for embedding texting and telephone communications into media items. According to one example embodiment of the present disclosure, a method for embedding messages into media items is provided. The method may include receiving, by a processor, a media item from a publisher. The media item may be associated with at least one of a product and a service. The method may continue with receiving, by the processor, metadata associated with at least one of the product and the service from the publisher. The method may continue with generating, by the processor, a widget based on the media item and the metadata. The widget may encode a Uniform Resource Locator (URL) that embeds the metadata associated with the media item and a protocol for accessing a webpage. The method may further include detecting, by the processor, an interaction of an end user with the widget. The method may continue with creating the webpage in response to the detection of the interaction. The webpage may display the media item based on the metadata and the protocol embedded into the URL and display a chat window with communications exchanged between the publisher and the end user.

According to another embodiment of the present disclosure, a system for embedding messages into media items is provided. The system may include a processor and a memory storing instructions to be executed by the processor. The processor may be configured to receive a media item from a publisher. The media item may be associated with at least one of a product and a service. The processor may be further configured to receive metadata associated with at least one of the product and the service from the publisher. The processor may be configured to generate a widget based on the media item and the metadata. The widget may encode an URL. The URL may embed the metadata associated with the media item and a protocol for accessing a webpage. The processor may be further configured to detect an interaction of an end user with the widget. In response to the detection, the processor may create the webpage. The webpage may display the media item based on the metadata and the protocol embedded into the URL and may display a chat window with communications exchanged between the publisher and the end user.

According to yet another example embodiment of the present disclosure, the operations of the above-mentioned method are stored on a machine-readable medium comprising instructions, which, when implemented by one or more processors, perform the recited operations.

Other example embodiments of the disclosure and aspects will become apparent from the following description taken in conjunction with the following drawings.

### BRIEF DESCRIPTION OF THE DRAWINGS

Exemplary embodiments are illustrated by way of example and not limitation in the figures of the accompanying drawings, in which like references indicate similar elements.

FIG. 1 is a block diagram of an example environment suitable for practicing systems and methods for embedding messages into media items, according to an example embodiment.

FIG. 2 is a block diagram illustrating a system for embedding messages into media items, according to an example embodiment.

FIG. 3 is a schematic diagram illustrating a user interface for receiving a media item and metadata from a publisher, according to an example embodiment.

FIG. 4 is a user interface showing a list of widgets generated by a system for embedding messages into media items for a publisher, according to an example embodiment.

FIG. 5 illustrates a user interface provided to a publisher for communicating with an end user, according to an example embodiment.

FIG. 6A illustrates a user interface provided to a user device of an end user when the end user visits an online resource, according to an example embodiment.

FIG. 6B illustrates a user interface provided to a user device of an end user upon interaction of the end user with a widget, according to an example embodiment.

FIG. 6C illustrates a user interface provided to a user device of an end user upon initiation of communication between the end user and a publisher, according to an example embodiment.

FIG. 7 illustrates a user interface provided to a user to make the user a publisher of a widget, according to an example embodiment.

FIG. 8 illustrates a user interface provided to a user to enable the user to provide metadata associated with a subject, according to an example embodiment.

FIG. 9 illustrates a user interface provided to a user to enable the user to provide further metadata associated with a subject, according to an example embodiment.

FIG. 10 illustrates a user interface provided to a user to enable the user to provide further metadata associated with a subject, according to an example embodiment.

FIG. 11 illustrates a user interface provided to a user to enable the user to provide contact information of the user, according to an example embodiment.

FIG. 12 illustrates a user interface showing a widget generated by a system for embedding messages into media items, according to an example embodiment.

FIG. 13 illustrates a user interface showing active conversations of a publisher, according to an example embodiment.

FIG. 14 illustrates a user interface showing active offers proposed to a publisher, according to an example embodiment.

FIG. 15 illustrates a user interface provided to a publisher upon accepting an offer by the publisher, according to an example embodiment.

FIG. 16 is a schematic diagram illustrating a webpage having widgets, according to an example embodiment.

FIG. 17 is a flow chart of a method for embedding messages into media items, according to an example embodiment.

FIG. 18 is a high-level block diagram illustrating an example computer system, within which a set of instructions for causing a machine to perform any one or more of the methodologies discussed herein can be executed.

### DETAILED DESCRIPTION

The following detailed description of embodiments includes references to the accompanying drawings, which form a part of the detailed description. Approaches described in this section are not prior art to the claims and are not admitted to be prior art by inclusion in this section. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and operational changes can be made without departing from the scope of what is claimed. The following detailed description is, therefore, not to be taken in a limiting sense, and the scope is defined by the appended claims and their equivalents.

Generally, the embodiments of this disclosure are concerned with systems and methods for embedding messages into media items. A system for embedding messages into media items of the present disclosure may be used to embed messaging and calling capabilities into media items, such as images, video, and audio. In one example embodiment, the system may receive a media item from a publisher (e.g., a product provider or a service provider). The media item may be an image or a video associated with a product and a service provided by the publisher. The publisher may further provide metadata associated with the media item. For example, the metadata may include description, price, and other information related to the product or the service. The system may receive the media item and the metadata and generate a widget based on the media item and the metadata. As used herein, a widget may include a web element that is configured to be embedded as an element into a webpage but is independent of the webpage and has limited or no interaction with the host of the webpage. In the course of generation of the widget, an URL may be encoded into the widget. The URL may embed the metadata associated with the media item and a protocol for accessing a webpage associated with the widget.

In an example embodiment, as the media item is embedded into the widget, the widget may visually look like the media item, for example, as an image. The widget may be configured to be embedded as an element into a website. The interaction of an end user with the widget may initiate opening of the URL encoded into the widget. More specifically, clicking the widget embedded into the website may initiate generation and opening of the webpage associated with the widget. The webpage may be generated based on the URL, the metadata, and the protocol embedded into the widget.

In an example embodiment, upon generation of the widget, the system may provide the widget to the publisher. The publisher may distribute the widget to prospective customers. For example, the publisher may publish the widget via online resources, send the widget via email and messengers, post the widget on social media, and so forth. When an end user of online resources or social media sees the widget, the end user may start interactions with the widget. For example, the end user may click the widget.

The system of the present disclosure may track interactions of the end user with the widget. In response to the detection of the interactions of the end user with the widget, the system may create the webpage. In particular, based on the metadata and the protocol embedded into the URL, the webpage created by the system may display the media item and a chat window for communications exchanged between the publisher and the end user. In an example embodiment, the chat window may be superimposed onto the media item so that the media item may act as a background of the webpage and the chat window may be displayed over the media item.

Upon displaying of the webpage with the media item and the chat window to the end user, the system may initiate communication of the publisher with the end user. In an example embodiment, the publisher may communicate with the end user in real time via the chat window. Specifically, upon opening of the webpage associated with the widget to the end user, the system may notify the publisher that the webpage was opened to the end user. The system may provide the publisher with a user interface for communicating with the end user via the chat window on the webpage. The publisher may use the user interface to send a message to the end user. For example, in the message, the publisher may ask the end user whether the end user wants to buy the product or the service shown in the media item. The message may be displayed to the end user in the chat window. The end user may respond to the publisher by sending messages in the chat window.

The system may provide the publisher with the ability to perform real time messaging with the end user. In particular, the publisher may communicate in real time with the end user by sending messages via the chat window superimposed onto the media item associated with the widget. Thus, the webpage created based on the data encoded in the widget may be a micro website with a custom URL, where the URL may include data related to the product or the service. The data related to the product or the service may include a product identifier, a vehicle identification number (VIN), a product number, and the like. Thus, the system may provide engaging end user communication via a widget (e.g., an image), may need no small message service (SMS), no phone numbers, and no applications, and may retain message communications for the time when the widget exists.

In another example embodiment, communications between the publisher and the end user may be managed by an Artificial Intelligence (AI) chatbot implemented via an AI unit. The AI unit may store predetermined messages with intents and utterances to be communicated via real time messaging on behalf of the publisher to the end user via the chat window opened to the end user in response to interaction of the end user with the widget.

The system of the present disclosure may provide a real time attribution by a media item (e.g., an image) and a source. In particular, the system provides instant attribution by media items indicating specific products in which the end user was interested, and by a source indicating specific online resources at which the end user clicked/tapped a widget to look at the product.

Thus, the system of the present disclosure is a communication platform configured to embed texting and telephone functionalities into media items (such as images, videos, documents, or other content) to make the communications granular and subject-driven and capture user data in realtime. The system does not use software applications, phone numbers, email, or signups through messaging platforms. Instead, the system makes the media items the communication medium and transforms content into a contextual communication channel with a prospective consumer. The parties (a publisher of widgets and an end user) connect through media items related to a subject.

The system uses the AI unit to detect when an end user is interacting with a widget (e.g., is viewing an image) and sends a message to prompt the engagement of the end user with the publisher. The communication with the end user may be person-to-person in realtime when the publisher communicates with the end user, or AI-to-person in realtime when an AI chatbot communicates with the end user.

Referring now to the drawings, various embodiments are described in which like reference numerals represent like parts and assemblies throughout the several views. It should be noted that the reference to various embodiments does not limit the scope of the claims attached hereto. Additionally, any examples outlined in this specification are not intended to be limiting and merely set forth some of the many possible embodiments for the appended claims.

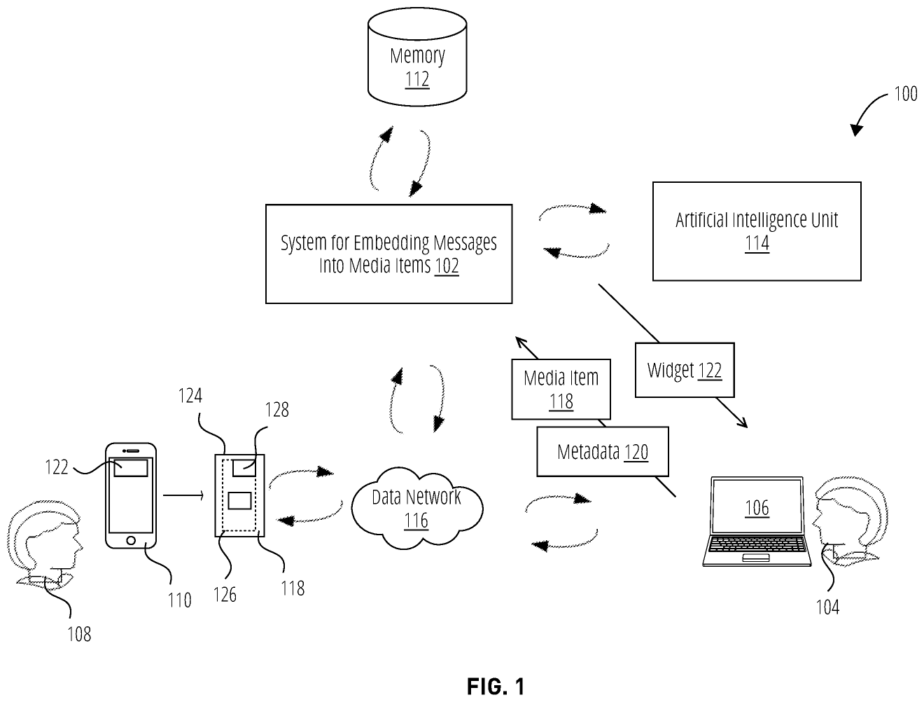

FIG. 1 shows a block diagram of an example environment 100 suitable for practicing methods described herein. It should be noted, however, that the environment 100 is just one example and is a simplified embodiment provided for illustrative purposes, and reasonable deviations of this embodiment are possible as will be evident to those skilled in the art.

As shown in FIG. 1, the environment 100 may include a system 102 for embedding messages into media items (also referred to herein as a system 102), a publisher 104, a user device 106 associated with the publisher 104, an end user 108, a user device 110 associated with the end user 108, a memory 112 associated with the system 102, an AI unit 114 associated with the system 102, and a data network 116.

In an example embodiment, the user device 106, the end user 108, and the system 102 may communicate with each other using the data network 116. The data network 116 can refer to any wired, wireless, or optical networks including, for example, the Internet, intranet, local area network (LAN), Personal Area Network, Wide Area Network (WAN), Virtual Private Network, cellular phone networks (e.g., Global System for Mobile (GSM) communications network), 3G, 4G, 5G network, Wi-Fi™ network, packet switching communications network, circuit switching communications network), Bluetooth™ radio, Ethernet network, an IEEE 802.11-based radio frequency network, a Frame Relay network, Internet Protocol (IP) communications network, or any other data communication network utilizing physical layers, link layer capability, or network layer to carry data packets, or any combinations of the above-listed data networks. In some embodiments, the data network 116 includes a corporate network, data center network, service provider network, mobile operator network, or any combinations thereof.

The publisher 104 may include a provider of a product or a service. The publisher 104 may provide a media item 118 to the system 102. The media item 118 may include, for example, an image associated with a product or a service provided by the publisher 104. The publisher 104 may further provide metadata 120 associated with the media item 118 to the system 102. The system 102 may receive the media item 118 and the metadata 120 from the publisher 104 and generate, based on the media item 118 and the metadata 120, a widget 122. The widget 122 may encode an URL. The URL may embed media item 118, the metadata 120 associated with the media item 118, and a protocol for accessing a webpage 124 to be generated upon interaction with the widget 122.

The system 102 may provide the widget 122 to the publisher 104. The publisher 104 may publish the widget 122 via online resources, such as websites, social media, emails, and the like. The end user 108 may visit an online resource (e.g., open a website) and interact, via the user device 110, with the widget 122 embedded into the online resource. Upon detection of the interaction of the end user 108 with the widget 122, the webpage 124 may be generated and opened to the end user 108 on the user device 110. The webpage 124 may display the media item 118 and a chat window 126 with communications 128 exchanged between the publisher 104 and the end user 108.

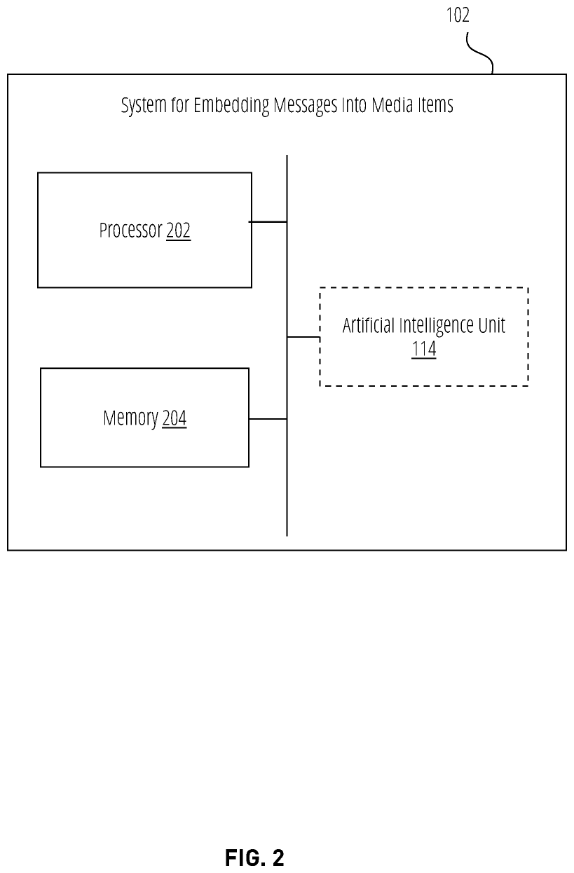

FIG. 2 is a block diagram illustrating a system 102 for embedding messages into media items, according to an example embodiment. The system 102 may include a processor 202 and a memory 204 configured to store instructions executable the processor 202. The processor 202 may be configured to receive a media item from a publisher. The media item may be associated with at least one of a product and a service. The product or the service associated with the media item is also referred to herein as a “subject.” In an example embodiment, the publisher may be a provider of a product or a service, i.e., a provider of a subject. In an example embodiment, the media item may include one of the following: an image, a video, an audio, text, and any other type of content. The image, video, audio, or text may illustrate or describe the subject provided by the publisher.

The processor 202 may be further configured to receive, from the publisher, metadata associated with at least one of the product and the service. In an example embodiment, the metadata may include description of the subject, a price, a time period of providing a special offer for selling the subject, contact information of the publisher, and so forth.

Based on the media item and the metadata, the processor 202 may generate a widget. The widget may encode an URL. The URL may embed the metadata associated with the media item and a protocol for accessing a webpage. In an example embodiment, the widget may be a wigitized image, i.e. may visually look like the media item, for example, as an image related to the subject. The widget may be configured to be embedded as an element into a website.

In an example embodiment, the widget may be embedded using an iFrame. The iFrame is a component of a HyperText Markup Language (HTML) element that allows embedding documents, videos, and interactive media within a webpage. In an example embodiment, the system 102 may provide a custom code to publish a widget in form of a wigitized image on a website.

In an example embodiment, the processor 202 may be further configured to share the widget via one or more online resources. The one or more online resources may be selected by the publisher or selected from a list of predetermined resources stored in a database. In an example embodiment, the database may be stored in the memory 204 of the system 102 or in a remote storage.

The processor 202 may be further configured to detect an interaction of an end user with the widget. In an example embodiment, the end user may want to buy a subject shown in the media item that is embedded into and displayed in the widget. The user may interact with the widget on the one or more online resources. The interaction of the end user with the widget may include one or more of the following: clicking the widget by the end user, tapping the widget by the end user, opening by the end user one or more online resources having the widget, and so forth.

In response to the detection of the interaction of the end user with the widget, the processor 202 may create the webpage. Based on the metadata and the protocol embedded into the URL, the webpage may display the media item and a chat window with communications exchanged between the publisher and the end user. On the webpage, the chat window may be superimposed onto the media item so that the media item may act as a background of the webpage and the chat window may be displayed over the media item. Upon the displaying of the chat window to the end user, the processor 202 may prompt the end user to communicate via the chat window. For example, a welcoming message may be sent to the end user and displayed in the chat window. In one example embodiment, the publisher may manually send the welcoming message.

In an example embodiment, the processor 202 may be further configured to establish a phone call communication channel between the end user and the publisher. To initiate establishing of the phone call communication, the end user may interact with the widget in a predetermined way. For example, the widget may have an icon named “tap here to call” or an icon with a phone ringer symbol. The end user may interact with the widget by tapping the icon. In response to the interaction, the processor 202 may trigger a user device of the end user to establish the phone call communication channel between the end user and the publisher.

In an example embodiment, the system 102 may optionally include an AI unit 114. The communications between the publisher and the end user may be managed by an AI chatbot controlled by the AI unit 114. In one example embodiment, the welcoming message may be sent to the end user by the AI chatbot. The AI unit 114 may select the welcoming message from a list of predetermined messages stored in the database. In an example embodiment, the AI unit 114 may also have natural language processing and machine learning capabilities.

In an example embodiment, the processor 202 may be further configured to collect data associated with the end user. Based on the collected data, the processor 202 may select an offer associated with at least one of the product and the service. Upon selection of the offer, the processor 202 may send the offer to the end user via the chat window.

In an example embodiment, the processor 202 may be further configured to collect realtime data related to the interaction of the end user with the widget. The realtime data may include an online resource on which the end user interacted with the widget, a time of interaction, a day of interaction, and so forth. The realtime data may be provided to the publisher. Based on the analysis of the realtime data, the publisher may determine which online resources, at what time, and on what days of the week provide higher engagement of the user with the widget and, eventually, with the subject that the end user wants to buy or receive from the publisher.

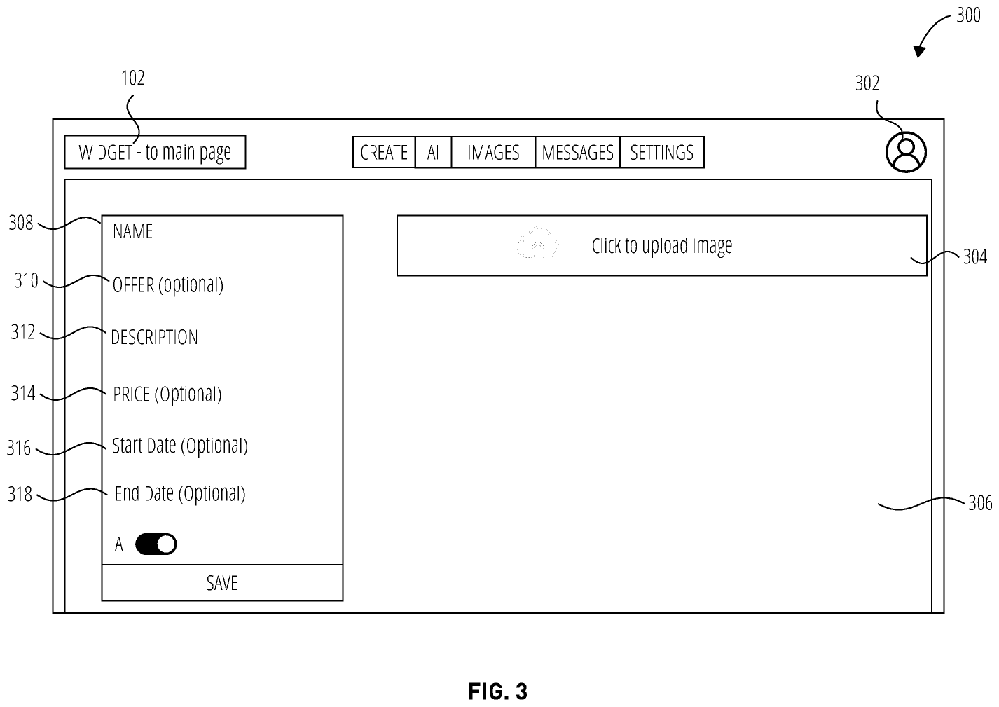

FIG. 3 is a schematic diagram illustrating a user interface 300 for receiving a media item and metadata from a publisher, according to an example embodiment. The system 102 may provide the user interface 300 to a user device of the publisher. The user interface 300 may enable the publisher to manually upload media items and metadata related to the media items to the system 102. In an example embodiment, the publisher may have a user profile 302 registered within the system 102. To provide the media item to the system 102, the publisher may click an upload icon 304 on the user interface 300. Upon clicking the upload icon 304, the publisher may select a storage place from which the media item needs to be uploaded to the system 102. In an example embodiment, the publisher may drag the media item from the storage place on the user device of the publisher and drop the media item into a window 306 of the user interface 300.

The publisher may further provide metadata related to the media item. In particular, the publisher may enter the metadata into metadata fields 308 of the user interface 300. The metadata may include a name 310 of a subject shown in the media item, an offer 312 provided for the subject shown in the media item, description 314 of the subject shown in the media item, a price 316 of the subject shown in the media item, a start date 318 of activation of the widget related to the media item, an end day 320 of the activation of the widget related to the media item, and so forth.

In an example embodiment, the system 102 may enable the publisher to automatically upload media items and metadata to the system 102. The publisher may have a database, such as an inventory database for centralized storing of inventory data, such as images and description of subjects provided by the publisher. The system 102 may include an Application Programming Interface (API) configured to receive media items and metadata from the database of the publisher. The publisher may connect the API to the inventory database to automatically upload media items and corresponding metadata to the system 102.

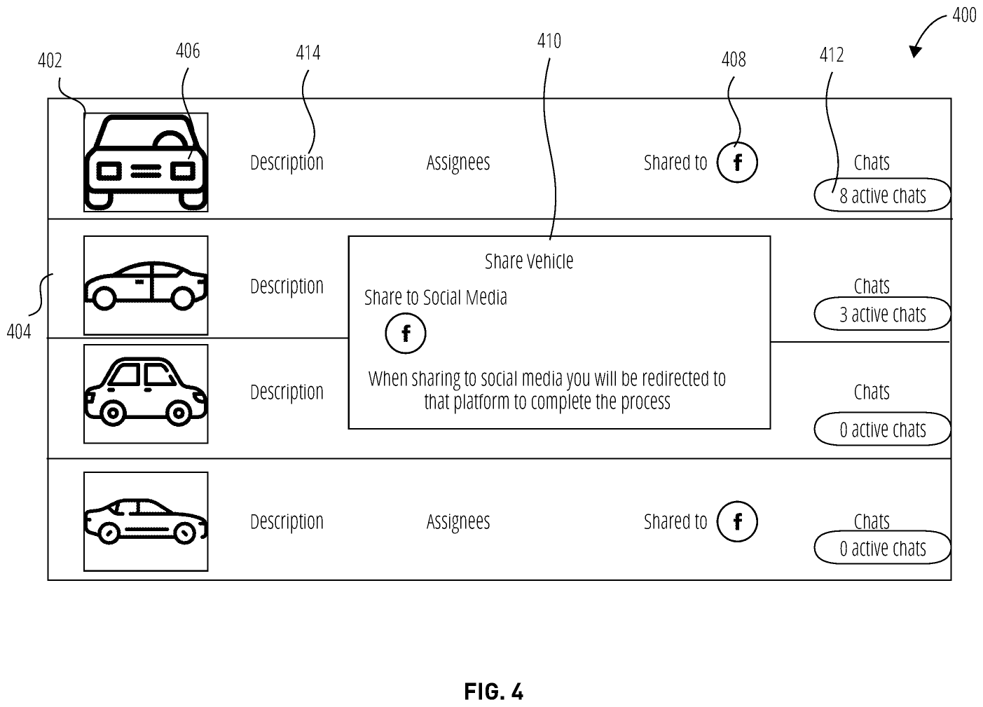

FIG. 4 is a user interface 400 showing a list 404 of widgets generated by the system 102 for the publisher, according to an example embodiment. Upon receiving a media item showing a subject and uploading metadata related to the subject using the user interface 300 shown in FIG. 3, the system 102 may generate a widget 402. The widget 402 may have a media item 406 (that was uploaded by the publisher) as a background of the widget 402. The widget 402 may also encode an URL that may embed the metadata related to the media item 406, such as description 414 of a subject shown on the media item 406. The URL may also embed a protocol for accessing a webpage to be generated on the fly upon interaction of an end user with the widget 402.

The publisher may use the user interface 400 to share the widget 402 on one or more online resources. The publisher may select an icon 408 related to an online resource, on which the publisher wants to publish the widget 402. Upon selection of the icon 408, a window 410 may be displayed informing the publisher about redirecting to the online resource to complete the process of sharing.

Upon publishing of the widget 402 via the online resource, the system 102 may track the interaction of end users of the online resource with the widget 402. Upon detection of the interaction, the system 102 may initiate communications with the end users. Active communications may be accessed by the publisher by selected an icon 412 named, for example, “X active chats” and indicating a number of communications with the end users initiated by the system 102.

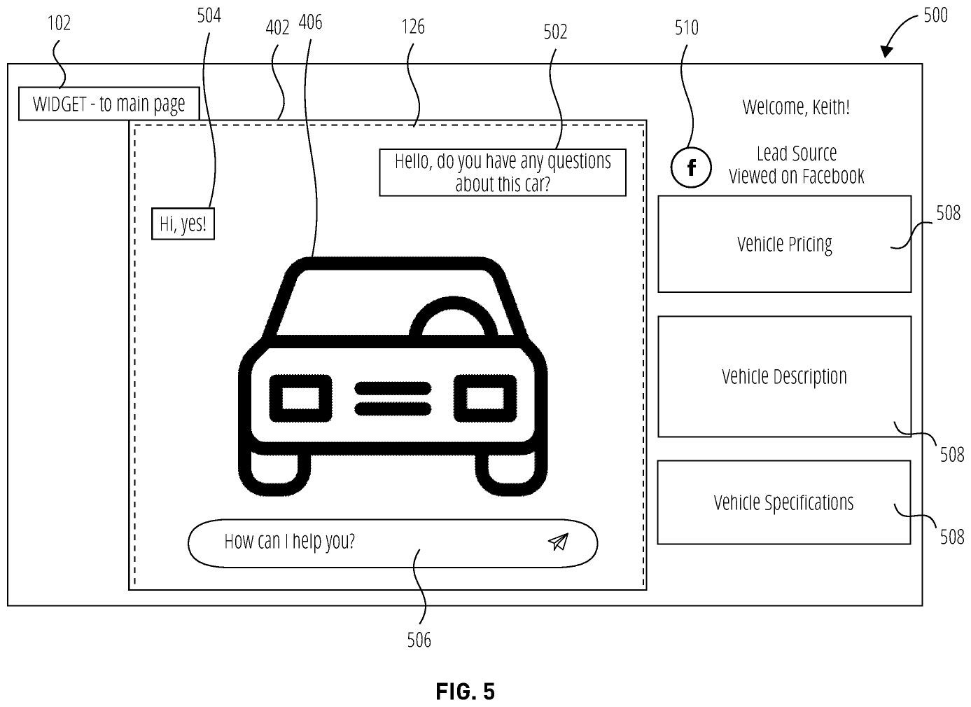

FIG. 5 illustrates a user interface 500 provided to a publisher for communicating with an end user, according to an example embodiment. Upon interaction of the end user with the widget on the online resource, the system 102 may initiate the communication with the end user. Specifically, the system 102 may provide the user interface 500 to the publisher to enable the publisher to enter a message to engage the end user into communication with the publisher.

The user interface 500 may display a widget 402. The widget 402 may have a media item 406 embedded into the widget 402. A chat window 126 may be superimposed onto the media item 406 so that the media item 406 may act as a background and the chat window 126 may be displayed over the media item 406.

To engage the end user into communication with the publisher, the publisher may send a message 502 via the chat window 126. The publisher may enter messages in an input field 506 of the chat window 126. The message 502 may be sent to the end user and the end user may respond to the publisher by sending a message 504. The message 504 sent by the end user may be displayed to the publisher in the chat window 126.

The user interface 500 may further display metadata 508 related to the subject shown in the media item 406. The metadata 508 may include a price, description, specification, and other information related to the subject associated with the media item 406.

The user interface 500 may further display source information 510 to the publisher. The source information 510 may indicate an online resource on which the end user interacted with the widget 402. Based on the source information 510, the publisher may determine, for each online resource, a level of interaction of end users with a widget published via the online resource. Therefore, the system 102 provides tracking a third party attribution by showing leads of new users received from third parties. The third parties may receive credit for providing the lead that is used by the publisher. Thus, the system 102 provides instant attribution for a source of customer generation on a granular basis by showing a single product or offer in which the customer became interested through a particular source on a particular date and time.

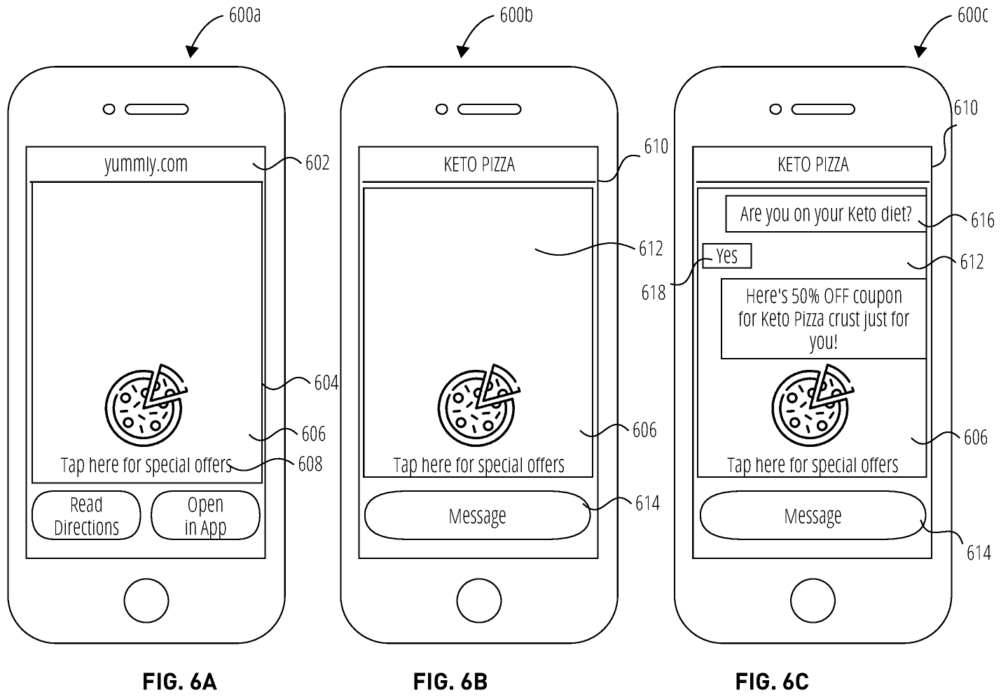

FIGS. 6A-6C show user interfaces provided to an end user upon interaction of the end user with a widget, according to an example embodiment. FIG. 6A illustrates a user interface 600a provided to a user device of an end user when the end user visits an online resource 602. The online resource 602 may include a website, a social media platform (Facebook®, Instagram®, Twitter®, Pinterest®, and so forth), an email (e.g., campaigns via emails, can be integrated with a customer relationship management (CRM) system of a publisher or be used standalone), an SMS (e.g., campaigns via SMS, can be integrated with a CRM system of a publisher or be used standalone), a blog, a messaging application, and so forth. A widget 604 may be integrated into the online resource 602. A media item 606 may be embedded into the widget 604. In an example embodiment, the media item 606 may include an image of a subject (e.g., a pizza) provided by a publisher of the widget 604. The widget 604 may include a notification 608 prompting the end user to interact with the widget 604. For example, the notification 608 may include a phrase “Tap here for special offers.” The end user may interact with the widget 604, for example, by tapping the widget 604. Therefore, the widget 604 may provide the end user with the “tap to chat” and “tap to call” possibility. The interactions of the end user with the widget 604 may be tracked by the system 102.

FIG. 6B illustrates a user interface 600b provided to the user device of the end user upon interaction of the end user with the widget 604. In response to the detection of the interaction of the end user with the widget 604, the system 102 may create a webpage 610 and display the webpage 610 on the user interface 600b. The webpage 610 may be created based on the metadata, the URL, and the protocol information embedded into the widget 604. The webpage 610 may display the media item 606 and a chat window 612. The media item 606 may act as a background of the webpage 610 and the chat window 612 may be superimposed onto the media item 606. The end user may enter messages using an input field 614.

FIG. 6C illustrates a user interface 600c provided to the user device of the end user upon initiation of communication between the end user and the publisher, according to an example embodiment. To initiate communication with the end user, the publisher may send a message 616 with a question relating to the subject. The message 616 may be displayed in the chat window 612. The end user may respond to the question by entering a message 618 in the input field 614. All messages sent by the publisher and the end user may be displayed in the chat window 612. In an example embodiment, the publisher may send a special offer (such as a coupon, a discount, a link to a website with an offer, and the like) to the end user in the chat window 612 to prompt the end user to buy the subject. The offer may be associated with a specific product shown on the media item embedded into the widget with which the end user interacted.

In an example embodiment, the system 102 may collect data associated with the end user, such as geographical location, time of visiting an online resource, information associated with the user device, and so forth. The selection of the offer to be provided to the end user may be made based on the collected data. For example, the end user may be geofenced based on the geographical location and an offer associated with a particular store within the geofence may be provided to the end user.

As the publisher knows with which widget the end user interacted, the publisher knows the subject in which the end user is interested and may directly start the communication related to the subject. Therefore, the publisher does not need to ask additional questions to determine in which product or service the end user is interested.

In an example embodiment, the publisher may send messages manually. In another example embodiment, the publisher may use an AI chatbot that may automatically send messages on behalf of the publisher to the end user. In a further example embodiment, the communication may be initiated by the AI chatbot and then transferred to a live operator associated with the publisher.

In an example embodiment, to provide the end user with the “tap to call” possibility, in response to the detection of the interaction of the end user with the widget 604, the system 102 may initiate a phone call from a user device of the end user to a user device of the publisher.

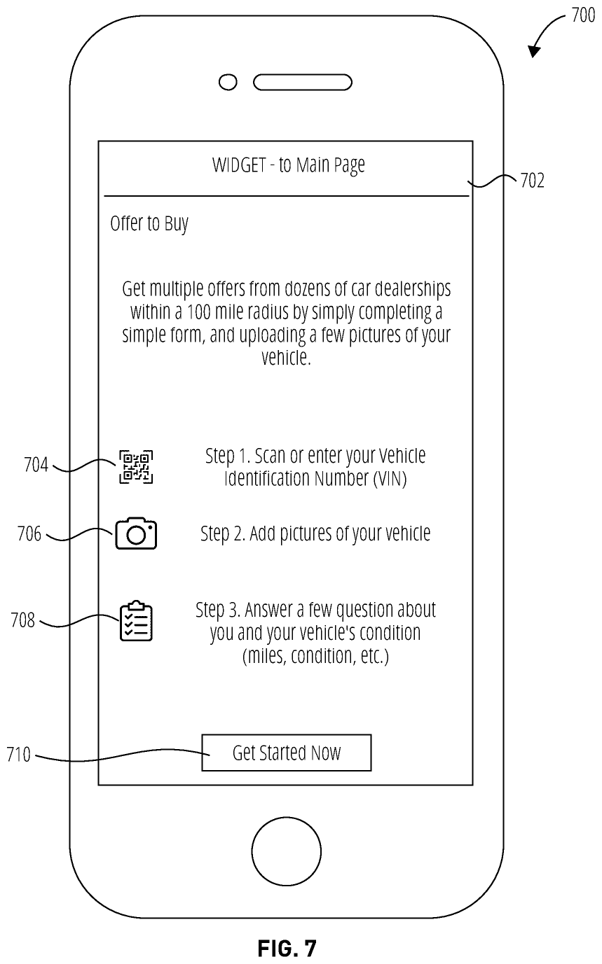

FIG. 7 illustrates a user interface 700 provided to a user by the system to make the user a publisher of a widget, according to an example embodiment. When the user wants to sell a subject (e.g., a vehicle as shown in FIG. 7), the user may use the system to create a widget associated with the subject, publish the widget via online resources, track interaction of end users of the online resources with the widget, and communicate with the end users that interacted with the widget. The user interface 700 may be provided to the user upon scanning of a quick response (QR) code associated with the system by the user or opening a link associated with the system by the user. Upon scanning of the QR code or following the link, the user may be directed to a website 702 having user interfaces illustrated in FIGS. 7-15. The user interface 700 shows the description of steps 704, 706, and 708 needed to create the widget associated with the subject. Upon selecting of a “Get Started Now” icon 710, a user interface 800 may be provided to the user.

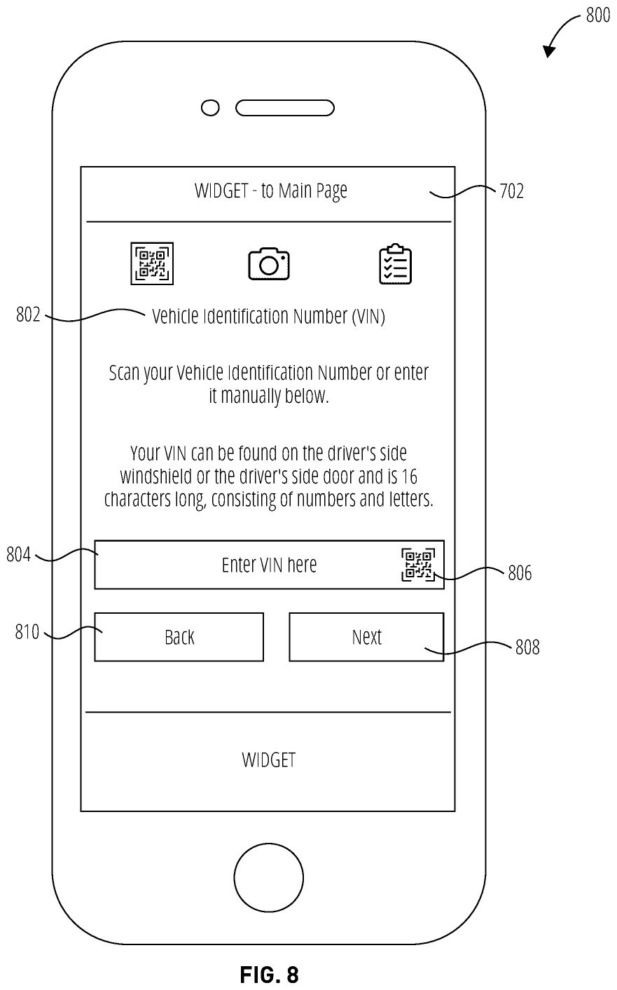

FIG. 8 illustrates a user interface 800 provided to the user to enable the user to provide metadata 802 associated with the subject, according to an example embodiment. In an example embodiment, the metadata 802 may include a Vehicle Identification Number (VIN) of the vehicle. The user may enter the VIN manually into an input field 804 or scan the VIN using a scan icon 806. Upon providing the metadata 802, the user may select a “Next” icon 808. If the user needs to return to the user interface 700, the user may select a “Back” icon 810.

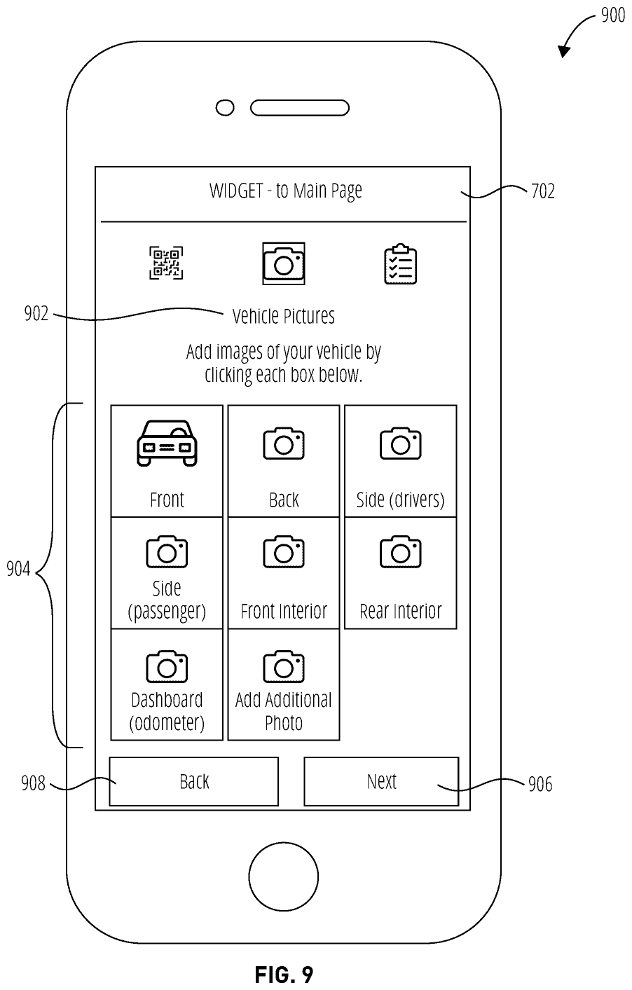

FIG. 9 illustrates a user interface 900 provided to the user to enable the user to provide further metadata 902 associated with the subject, according to an example embodiment. In an example embodiment, the metadata 902 may include media items associated with the subject, for example, pictures of the vehicle. The user may upload the pictures from a picture gallery of a user device. In another embodiment, the user may take the pictures directly through the user interface 900 by selecting corresponding picture icons 904 and making the pictures of the vehicle. Upon providing the metadata 902, the user may select a “Next” icon 906. If the user needs to return to the user interface 80000, the user may select a “Back” icon 908.

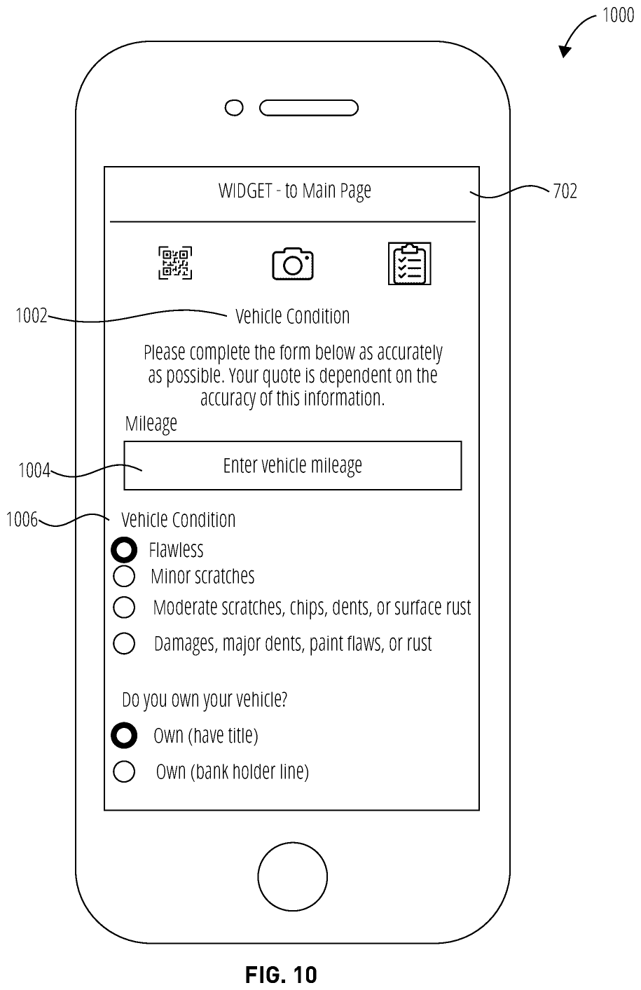

FIG. 10 illustrates a user interface 1000 provided to the user to enable the user to provide further metadata 1002 associated with the subject, according to an example embodiment. In an example embodiment, the metadata 1002 may include the description of the subject, e.g., a condition of a vehicle. The user may enter the description into an input field 1004. In another embodiment, the user may provide the metadata 1002 by answering questions from a list 1006 displayed on the user interface 1000.

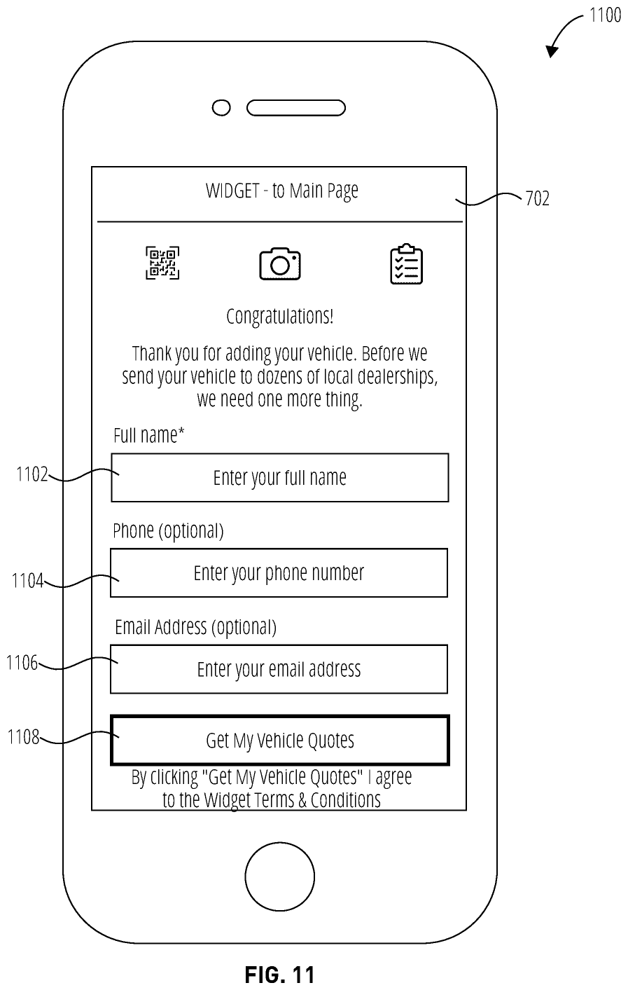

FIG. 11 illustrates a user interface 1100 provided to the user to enable the user to provide contact information of the user, according to an example embodiment. The user may enter the contact information of the user into input fields 1102, 1104, and 1106.

Upon selecting of an icon 1108 by the user, the system may create the widget associated with the subject. The system may generate the widget based on the media items and the metadata associated with the subject. The widget is intended to be published via online resources. In an example embodiment, the system 102 may send the widget to online resources, for examples, emails of vehicle dealers. Therefore, the user becomes a publisher of the widget. The widget may encode an URL that may embed the metadata associated with the media item 1204 and a protocol for accessing a webpage to be generated upon interaction of end users with the widget. The system 102 may track interactions of the end users with the widgets published via online resources.

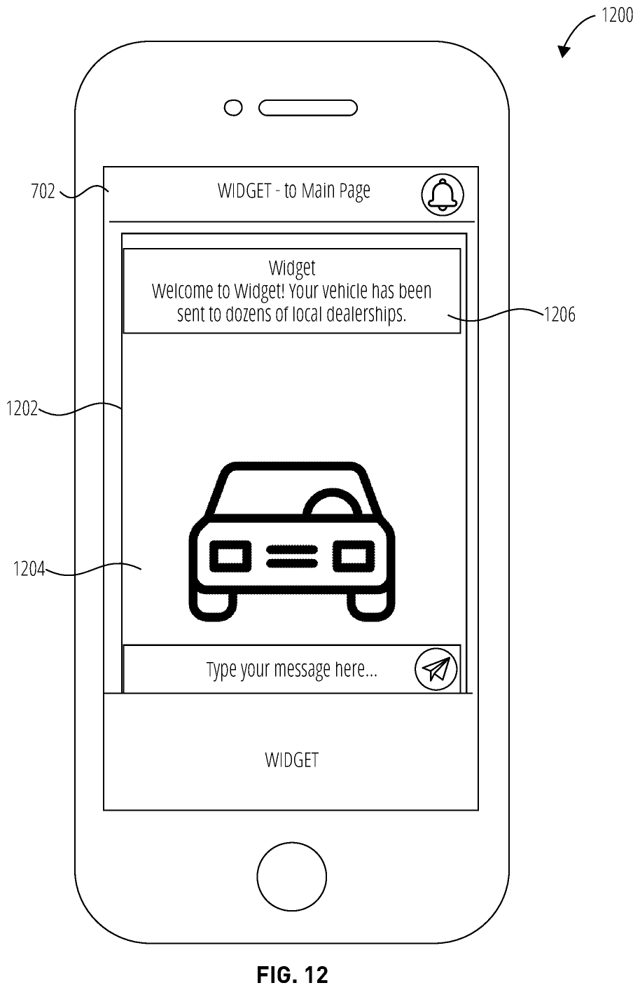

FIG. 12 illustrates a user interface 1200 showing a webpage generated by the system, according to an example embodiment. Upon receiving the media items and the metadata associated with the subject, the system 102 may generate a webpage 1202. The system may associate the webpage 1202 with the widget created by the system. The webpage 1202 may have a media item 1204 acting as a background of the webpage 1202. The media item 1204 may include one of pictures provided by the user. The webpage 1202 may further include a chat window 1206 superimposed onto the media item 1204.

Upon detection of the interactions of an end user with the widget on online resources, the system 102 may notify the user about the interactions via the user interface 1200. For example, the user interface 1200 may display messages sent by the end user in the chat window 1206.

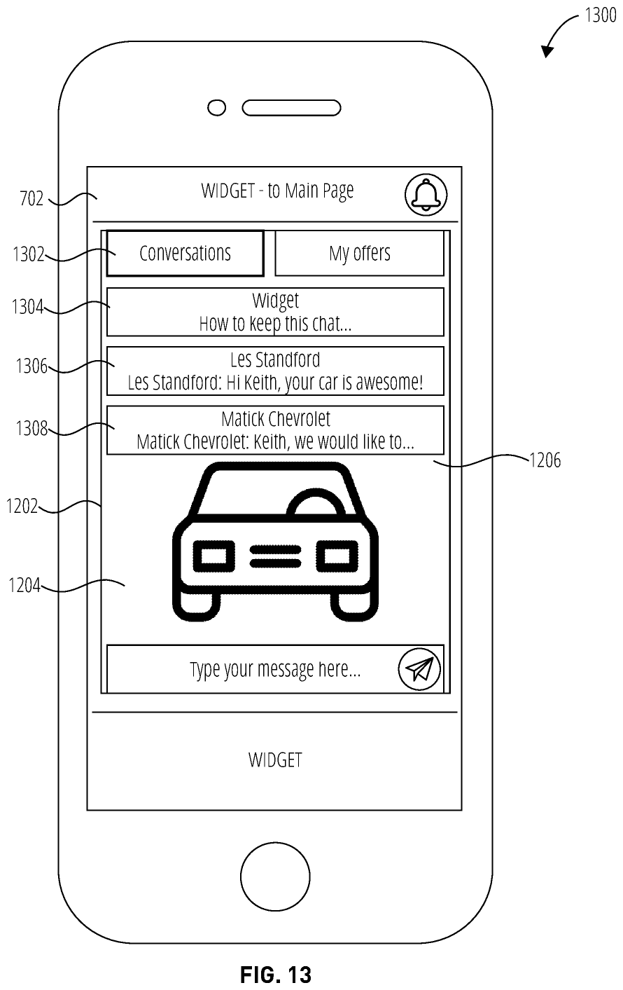

FIG. 13 illustrates a user interface 1300 showing active conversations of the publisher, according to an example embodiment. Upon selecting of a “Conversations” icon 1302, a list of conversations 1304, 1306, and 1308 may be displayed to the publisher. Each of the conversations 1304, 1306, and 1308 is a conversation initiated by one of the end users. To communicate with one of the end user, the publisher may select one of the conversations 1304, 1306, and 1308.

In an example embodiment, realtime notifications may be provided to the publisher informing the publisher that a message from an end user is waiting. Therefore, no notifying by SMS, no phone number of the publisher, and no software applications are needed for providing the communication between the publisher and the end user.

In an example embodiment, realtime notifications may be provided to the end user informing the end user that a message from the publisher is waiting. Therefore, no notifying by SMS, no phone number of the end user, and no software applications are needed for providing the communication between the end user and the publisher.

In an example embodiment, a dashboard and message window may be provided to the publisher to reflect attribution instantly by a media item (an image) and by a source (an online resource).

In an example embodiment, reports may be provided to the publisher on attribution provided by media items and sources. To receive a report, the publisher may extract a report file from the system 102.

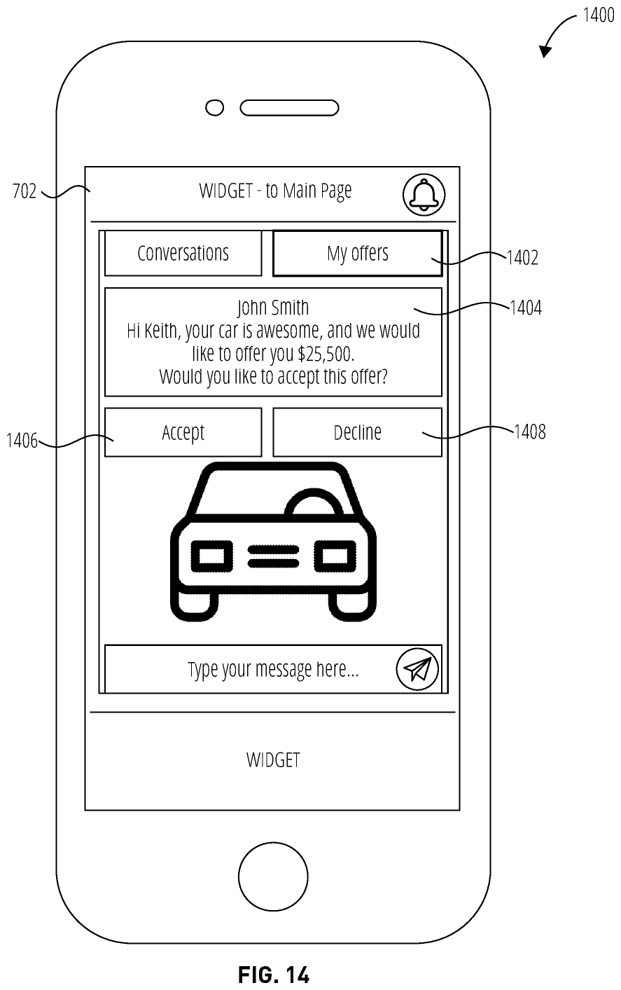

FIG. 14 illustrates a user interface 1400 showing active offers proposed to the publisher, according to an example embodiment. Upon selecting an “Offer” icon 1402, a list of offers 1404 may be displayed to the publisher. The publisher may accept the selected offer by selecting an “Accept” icon 1406 or decline the offer by selecting a “Decline” icon 1408.

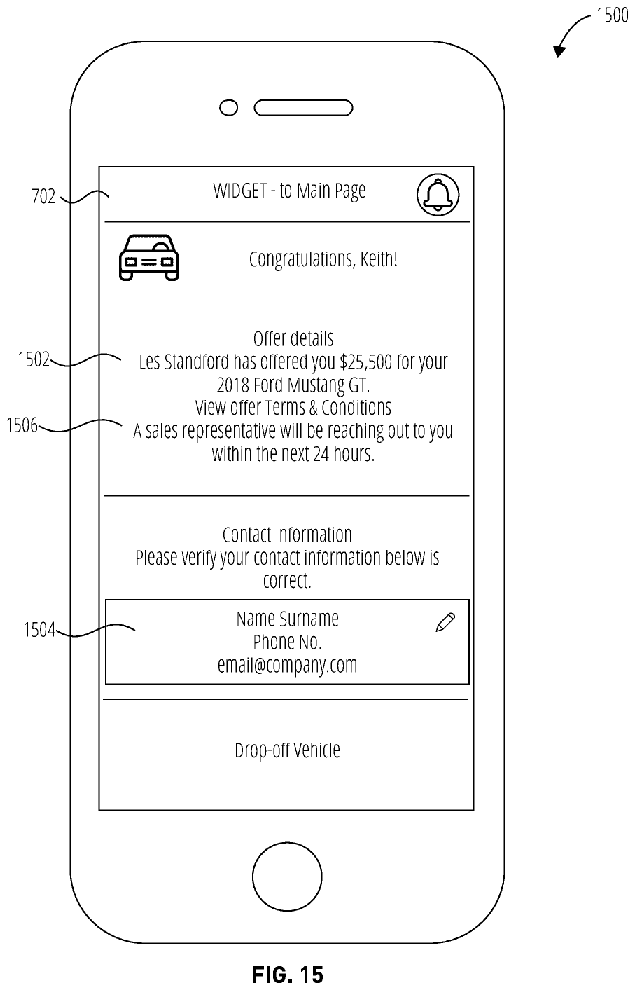

FIG. 15 illustrates a user interface 1500 provided to the publisher upon accepting the offer by the publisher, according to an example embodiment. The user interface 1500 may display offer information 1502, contact information 1504 of the publisher, and other details related to the offer. The further details may include a notification 1506 informing the publisher that a vehicle dealer will contact the publisher soon. The vehicle dealer may be associated with the online resource of which the end user interacted with the widget.

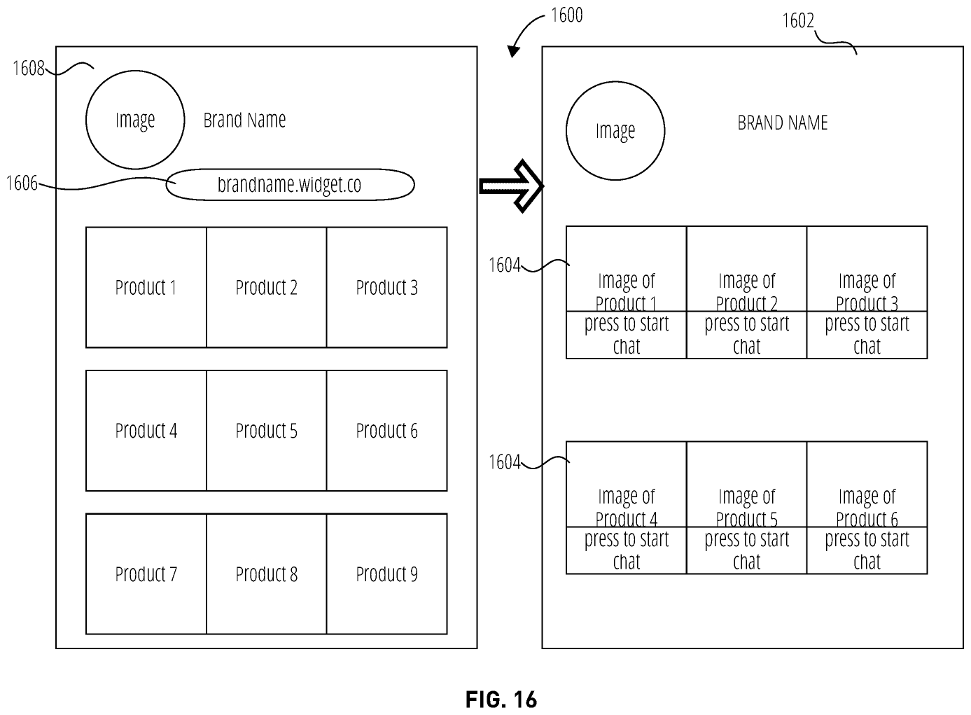

FIG. 16 is a schematic diagram 1600 illustrating a webpage having widgets, according to an example embodiment. The publisher may use the system 102 to create a webpage 1602 with a plurality of widgets 1604. Each of the widget 1604 may have a media item (e.g., an image related to a product or a service provided by the publisher). The publisher may publish a link 1606 on an online resource 1608, such as a social media. When an end user opens the link 1606 on the online resource 1608, the webpage 1602 may be opened to the end user. Upon reviewing the webpage 1602, the end user may want to know more about one of the products and may interact (e.g., by tapping) with the widget 1604 that displays the product. Upon detection of the interaction of the end user with the widget 1604, a webpage displaying the media item and the chat window may be created by the system 102 and displayed to the end user (as shown in FIGS. 6B and 6C). The end user may communicate with the publisher using the chat window.

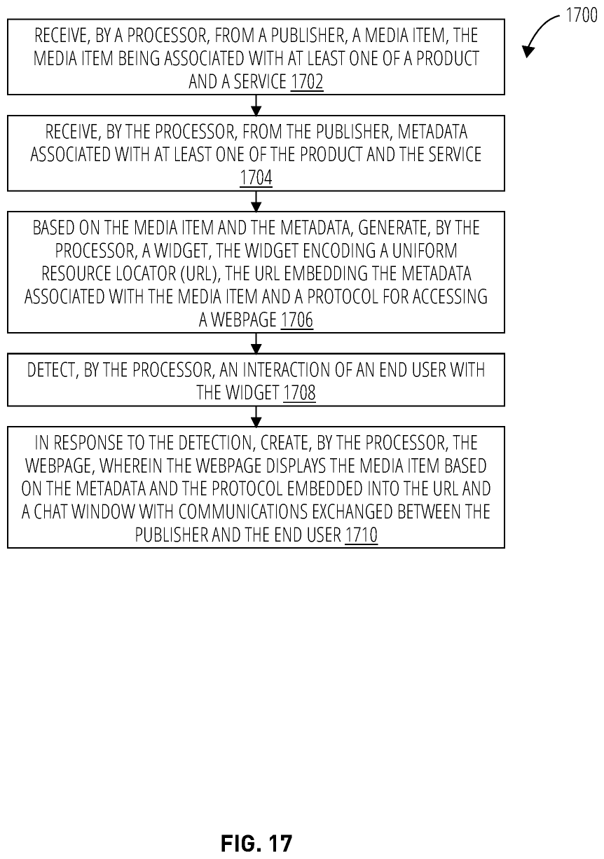

FIG. 17 is a flow chart of a method 1700 for method for embedding messages into media items, according to an example embodiment. In some embodiments, the operations may be combined, performed in parallel, or performed in a different order. The method 1700 may also include additional or fewer operations than those illustrated. The method 1700 may be performed by processing logic that may comprise hardware (e.g., a decision making logic, a dedicated logic, a programmable logic, and a microcode), software (such as software run on a general-purpose computer system or a dedicated machine), or a combination of both.

The method 1700 may commence in block 1702 with receiving a media item from a publisher. The media item may be associated with at least one of a product and a service. In an example embodiment, the media item may include one of the following: an image, a video, an audio, and the like. In block 1704, the method 1700 may include receiving, from the publisher, metadata associated with at least one of the product and the service.

In block 1706, the method 1700 may include generating a widget based on the media item and the metadata. The widget may encode an URL that may embed the metadata associated with the media item and a protocol for accessing a webpage.

In an example embodiment, the method 1700 may optionally include sharing the widget via one or more online resources. The one or more online resources may be selected by the publisher or selected from a list of predetermined resources stored in a database. In block 1708, the method 1700 may continue with detecting an interaction of an end user with the widget. In an example embodiment, the end user may interact with the widget via the one or more online resources. The interaction may include one or more of the following: clicking the widget by the end user, tapping the widget by the end user, opening by the end user one or more online resources having the widget, and so forth.

In block 1710, the method 1700 may include creating the webpage in response to the detection of the interaction of the end user with the widget. The webpage may display the media item based on the metadata and the protocol embedded into the URL and a chat window with communications exchanged between the publisher and the end user. The chat window may be superimposed on the media item on the webpage.

In an example embodiment, the communications between the publisher and the end user may be managed manually by the publisher. In a further example embodiment, the communications between the publisher and the end user may be managed by an AI chatbot on behalf of the publisher.

In an example embodiment, the method 1700 may further optionally include establishing a phone call communication channel. The phone call communication channel may be established in response to the detection of the interaction of the end user with the widget.

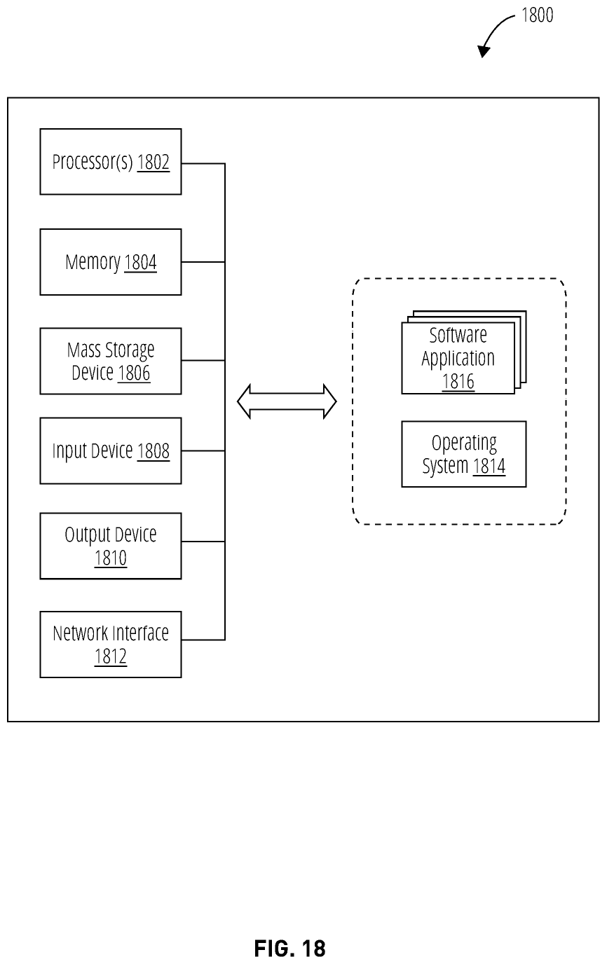

FIG. 18 is a high-level block diagram illustrating an example computer system 1800, within which a set of instructions for causing a machine to perform any one or more of the methodologies discussed herein can be executed. The computer system 1800 may include, refer to, or be an integral part of, one or more of a variety of types of devices, such as a general-purpose computer, a desktop computer, a laptop computer, a tablet computer, a netbook, a mobile phone, a smartphone, a personal digital computer, a smart television device, and a server, among others. In some embodiments, the computer system 1800 is an example of user devices 106, user devices 110, or a system 102 shown in FIG. 1. Notably, FIG. 18 illustrates just one example of the computer system 1800 and, in some embodiments, the computer system 1800 may have fewer elements/modules than shown in FIG. 18 or more elements/modules than shown in FIG. 18.

The computer system 1800 may include one or more processor(s) 1802, a memory 1804, one or more mass storage devices 1806, one or more input devices 1808, one or more output devices 1810, and a network interface 1812. The processor(s) 1802 are, in some examples, configured to implement functionality and/or process instructions for execution within the computer system 1800. For example, the processor(s) 1802 may process instructions stored in the memory 1804 and/or instructions stored on the mass storage devices 1806. Such instructions may include components of an operating system 1814 or software applications 1816. The computer system 1800 may also include one or more additional components not shown in FIG. 18.

The memory 1804, according to one example, is configured to store information within the computer system 1800 during operation. The memory 1804, in some example embodiments, may refer to a non-transitory computer-readable storage medium or a computer-readable storage device. In some examples, the memory 1804 is a temporary memory, meaning that a primary purpose of the memory 1804 may not be long-term storage. The memory 1804 may also refer to a volatile memory, meaning that the memory 1804 does not maintain stored contents when the memory 1804 is not receiving power. Examples of volatile memories include random access memories (RAM), dynamic random access memories (DRAM), static random access memories (SRAM), and other forms of volatile memories known in the art. In some examples, the memory 1804 is used to store program instructions for execution by the processor(s) 1802. The memory 1804, in one example, is used by software (e.g., the operating system 1814 or the software applications 1816). Generally, the software applications 1816 refer to software applications suitable for implementing at least some operations of the methods for embedding messages into media items as described herein.

The mass storage devices 1806 may include one or more transitory or non-transitory computer-readable storage media and/or computer-readable storage devices. In some embodiments, the mass storage devices 1806 may be configured to store greater amounts of information than the memory 1804. The mass storage devices 1806 may further be configured for long-term storage of information. In some examples, the mass storage devices 1806 include non-volatile storage elements. Examples of such non-volatile storage elements include magnetic hard discs, optical discs, solid-state discs, flash memories, forms of electrically programmable memories (EPROM) or electrically erasable and programmable memories, and other forms of non-volatile memories known in the art.

The input devices 1808, in some examples, may be configured to receive input from a user through tactile, audio, video, or biometric channels. Examples of the input devices 1808 may include a keyboard, a keypad, a mouse, a trackball, a touchscreen, a touchpad, a microphone, one or more video cameras, image sensors, fingerprint sensors, or any other device capable of detecting an input from a user or other source, and relaying the input to the computer system 1800, or components thereof.

The output devices 1810, in some examples, may be configured to provide output to a user through visual or auditory channels. The output devices 1810 may include a video graphics adapter card, a liquid crystal display monitor, a light emitting diode (LED) monitor, an organic LED monitor, a sound card, a speaker, a lighting device, a LED, a projector, or any other device capable of generating output that may be intelligible to a user. The output devices 1810 may also include a touchscreen, a presence-sensitive display, or other input/output capable displays known in the art.

The network interface 1812 of the computer system 1800, in some example embodiments, can be utilized to communicate with external devices via one or more data networks such as one or more wired, wireless, or optical networks including, for example, the Internet, intranet, LAN, WAN, cellular phone networks, Bluetooth radio, and an IEEE 902.11-based radio frequency network, Wi-Fi networks®, among others. The network interface 1812 may be a network interface card, such as an Ethernet card, an optical transceiver, a radio frequency transceiver, or any other type of device that can send and receive information.

The operating system 1814 may control one or more functionalities of the computer system 1800 and/or components thereof. For example, the operating system 1814 may interact with the software applications 1816 and may facilitate one or more interactions between the software applications 1816 and components of the computer system 1800. As shown in FIG. 18, the operating system 1814 may interact with or be otherwise coupled to the software applications 1816 and components thereof. In some embodiments, the software applications 1816 may be included in the operating system 1814. In these and other examples, virtual modules, firmware, or software may be part of the software applications 1816.

Thus, systems and methods for embedding messages into media items have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A method for embedding messages into media items, the method comprising:
receiving, by a processor, from a publisher, a media item, the media item being associated with at least one of a product and a service;
receiving, by the processor, from the publisher, metadata associated with at least one of the product and the service;
based on the media item and the metadata, generating, by the processor, a widget, the widget encoding a Uniform Resource Locator (URL), the URL embedding the metadata associated with the media item and a protocol for accessing a webpage;
detecting, by the processor, an interaction of an end user with the widget; and
in response to the detection, creating, by the processor, the webpage, wherein the webpage displays the media item based on the metadata and the protocol embedded into the URL and a chat window with communications exchanged between the publisher and the end user.

2. The method of claim 1, wherein the media item includes one of the following: an image, a video, and an audio.

3. The method of claim 1, further comprising sharing, by the processor, the widget via one or more online resources, wherein the one or more online resources are selected by the publisher or selected from a list of predetermined resources stored in a database.

4. The method of claim 3, wherein the end user interacts with the widget via the one or more online resources.

5. The method of claim 1, wherein the interaction includes one or more of the following: clicking the widget by the end user, tapping the widget by the end user, and opening by the end user one or more online resources having the widget.

6. The method of claim 1, wherein the chat window is superimposed on the media item on the webpage.

7. The method of claim 1, further comprising establishing a phone call communication channel.

8. The method of claim 1, wherein the communications between the publisher and the end user are managed by an Artificial Intelligence (AI) chatbot.

9. The method of claim 1, further comprising:
collecting data associated with the end user;
based on the collected data, selecting an offer associated with at least one of the product and the service; and
sending the offer to the end user via the chat window.

10. The method of claim 1, further comprising, upon the displaying of the chat window, prompting the end user to communicate via the chat window.

11. A system for embedding messages into media items, the system comprising:
a processor; and
a memory storing instructions that, when executed by the processor, configure the processor to:
receive, from a publisher, a media item, the media item being associated with at least one of a product and a service;
receive, from the publisher, metadata associated with at least one of the product and the service;
based on the media item and the metadata, generate a widget, the widget encoding a Uniform Resource Locator (URL), the URL embedding the metadata associated with the media item and a protocol for accessing a webpage;
detect an interaction of an end user with the widget; and
in response to the detection, create the webpage, wherein the webpage displays the media item based on the metadata and the protocol embedded into the URL and a chat window with communications exchanged between the publisher and the end user.

12. The system of claim 11, wherein the media item includes one of the following: an image, a video, and an audio.

13. The system of claim 11, wherein the processor is further configured to share the widget via one or more online resources, wherein the one or more online resources are selected by the publisher or selected from a list of predetermined resources stored in a database.

14. The system of claim 13, wherein the end user interacts with the widget via the one or more online resources.

15. The system of claim 11, wherein the interaction includes one or more of the following: clicking the widget by the end user, tapping the widget by the end user, and opening by the end user one or more online resources having the widget.

16. The system of claim 11, wherein the chat window is superimposed on the media item on the webpage.

17. The system of claim 11, wherein the processor is further configured to establish a phone call communication channel.

18. The system of claim 11, wherein the communications between the publisher and the end user are managed by an Artificial Intelligence (AI) chatbot.

19. The system of claim 11, wherein the processor is further configured to:
collect data associated with the end user;
based on the collected data, select an offer associated with at least one of the product and the service; and
send the offer to the end user via the chat window.

20. A non-transitory computer-readable storage medium, the non-transitory computer-readable storage medium including instructions that, when executed by a processor, cause the processor to:
receive, from a publisher, a media item, the media item being associated with at least one of a product and a service;
receive, from the publisher, metadata associated with at least one of the product and the service;
based on the media item and the metadata, generate a widget, the widget encoding a Uniform Resource Locator (URL), the URL embedding the metadata associated with the media item and a protocol for accessing a webpage;
detect an interaction of an end user with the widget; and
in response to the detection, create the webpage, wherein the webpage displays the media item based on the metadata and the protocol embedded into the URL and a chat window with communications exchanged between the publisher and the end user.
